(19) United States
(12) Patent Application Publication
(10) Pub. No.: US 2008/0148633 A1
(43) Pub. Date: Jun. 26, 2008

(54) Robot for Caring for Plants

(76) Inventor: Sara Cinnamon Singh, Boston, MA (US)

Correspondence Address: SARA SINGH, 82 CHARLES ST., # 1-R, BOSTON, MA, 02114, US

(21) Appl. No.: 11/531,689

(22) Filed: Sep. 13, 2006

Related U.S. Application Data
(60) Provisional application No. 60/596,290, filed on Sep. 13, 2005.

(51) Int. Cl. A01G 27/00

(52) U.S. Cl. 47/65

(57) ABSTRACT

This invention is a robot that enables efficient care of plants within the home or office environment via sensor readings and actuators which influence the environment accordingly. Several of these robots may be active at the same time, which leads to opportunities for cooperation and competition among these autonomous agents.

### CROSS-REFERENCE TO RELATED APPLICATIONS

This application claims the benefit of PPA Ser. No. 60/596,290, filed 2005 Sep 13 by the present inventor.

### BACKGROUND OF THE INVENTION—FIELD OF THE INVENTION

This invention relates to robotics and plant care, specifically to an automatic way of caring for plants.

### BACKGROUND OF THE INVENTION—PRIOR ART

Previously, there have been automatic plant waterers on the market, targeted specifically for travelers or those who are forgetful. In these systems, the plants would be clustered around a central location where water would be metered into each pot (e.g. Oasis Automatic Home Watering System). There is another embodiment where the water is pulled up from a reservoir via osmosis (e.g. Osmogro Houseplant Watering System) or leeched out of a container inserted in the soil (e.g. Plantastic or Perky Posey Plant Watering System). The first system is at a disadvantage because the user must leave all their plants in one location, rather than decorated about the environment. It also uses unsightly tubing and water reservoir that cannot be integrated subtly with the decor. It offers four preset watering rates, but cannot be modified outside of this range. It is only useful to one leaving for vacation who merely wants the plants to survive the duration of his/her journey. The second style of system, which uses osmosis or a slow drip from a reservoir located proximate to the plant container, also suffers from a lack of controllability or adaptation to the plant specie in question. There are no devices currently on the market that help the plant get the light that it needs.

### BACKGROUND OF THE INVENTION—OBJECTS AND ADVANTAGES

Accordingly, several objects and advantages of my invention are that the devices can be placed anywhere within the environment that a user would normally want to place a houseplant, they can be used continuously and as part of normal routine, the amount of water delivered is customized to the plant's species and current condition, and the device brings the plant to areas of greater sunlight, if necessary.

The device can be integrated with the container of the plant and does not need to be much bigger than the base of the container to perform the necessary functions. Thus the overall size of a plant's container will not change due to the addition of my invention. The device may also be an aesthetic addition to the decor, integrated with the existing decor, thus adding to the ambience rather than detracting from it with unsightly tubing or other components. Also, the device is useful continuously, rather than only when the owner is on vacation, and as such can be used for the duration of the plant's life.

The invention utilizes a sensor in the soil that can determine the moisture content. This, along with the feature that the user can input the type of soil conditions that the given species of plant prefers allow the computer program to control the amount of water introduced into the soil precisely for the needs of the plant at hand. This ensures that varying types of plants, such as cacti versus violets, for example, will receive the proper amount of water given other environmental conditions including ambient humidity and temperature, that other systems cannot compensate for.

Additionally, by dint of being a wheeled mobile robot, the invention can bring the plant to areas of greater sunlight, one of the most important aspects of plant care, and the least likely to be satisfied when arrayed about the typical environment. Since plants are not mobile of their own accord naturally, they are subject to the limitations of the location determined by the owner. With this system, however, the plant may now travel to the light it needs. The invention uses sensors and a computer program to determine the location of light as well as cumulative light exposure, which in turn determines the plant's need for more or less light. This invention effectively gives care of the plant over to the robot and away from the responsibility of the owner. This invention allows the user to make plants an integrated part of the environs, rather that needing to have all plants clustered in the limited area near windows to receive sufficient light.

Further objects and advantages of my invention will become apparent from a consideration of the drawings and ensuing descriptions.

### SUMMARY

The invention is a robot that meters water and sunlight exposure for the optimal health of a houseplant. It does so by way of sensors and a computer program that monitor environmental conditions and takes action accordingly.

### DRAWINGS

FIG. 1 shows a base with wheels situated underneath a potted plant.

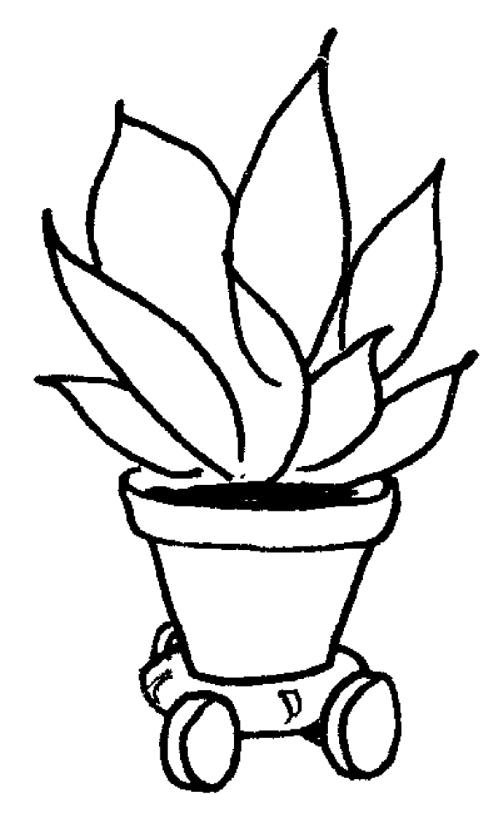

### DESCRIPTION AND OPERATION OF PREFERRED EMBODIMENT—FIG. 1

A mobile robot that cares for houseplants, or enables houseplants to care for themselves.

This patent describes a robot that senses the environment around a plant and uses these sensor readings to infer the needs of the plant. This robot can also be made mobile to proactively provide sustenance to said plant. The amount of said sustenance is determined by a computer program based on the sensor readings.

The mobile robot is a multi-wheeled machine that is propelled by at least one motor. Said robot carries a houseplant through an environment such as a home or office towards sunlight while avoiding obstacles. The robot can be made autonomous, where autonomous means that all of the actions carried out by the robot are made without direct input from a human. The robot is programmed to find light, and it may also either seek out water, deliver water, and/or indicate to the user when the plant needs water. The robot may be set by the user to operate from a given location and during a fixed period of time.

To perform these functions in a non-empty environment, a navigation system may be implemented to guide the robot away from obstacles. Obstacles and edges may be detected by multiple infrared and/or sonar distance sensors.

The robot may also store a map of the environment. This map may be created by the robot or given to the robot by the user. It may then use this map to return to its starting position. A battery charging station may be located in this starting position. The starting position may also contain a beacon to draw the robot back to its origin in addition to or in place of a stored map of the environment.

The user may input the species, and the program may look up the ideal conditions for the given plant. The user may input the conditions manually based on information found in any number of plant care resources.

The actions of the robot are determined by a sub-program. Such a program may be based on homeostasis. The amount of sunlight accrued over the course of the day may be stored in the robot's memory. The robot may also be designed to access the internet wirelessly itself and/or through its charging dock to query a website for the weather. Multiple autonomous robots collocated in the same area may be allowed to share information. These collocated robots may also compete for resources.

### DESCRIPTION AND OPERATION OF ALTERNATIVE EMBODIMENTS

There are several possible alternative configurations for this invention. For instance, one could elect to omit the light-seeking functions and/or the mobility function and rely on the device solely as a watering system for a plant. Similarly, one could use the device to find light and use traditional means of watering the plant by hand. One could also use the mobile platform as a means for moving things other than plants around an environment. The invention does not have to be limited to living organisms either. The function of sensing the environs and using that information to act on behalf of another entity can be applied to several other situations not yet enumerated. One example is of an aquarium where the chemical levels are measured and the water quality influenced by automatic means to maintain conditions favorable to the aquarium's inhabitants. Another is a device which senses the restlessness of an infant through motion or sound or some other modality and initializes some action that would serve to calm said infant.

### CONCLUSION, RAMIFICATIONS, AND SCOPE

Accordingly the reader will see that the invention described herein will improve the health and well-being of an organism in its care with minimal input from a human and a high level of integration with the environment without altering said environment significantly.

While the above description contains many specificities, these should not be construed as limitations on the scope of the invention, but as exemplifications of the presently preferred embodiments thereof. Many other ramifications and variations are possible within the teachings of the invention. For example, the aquarium monitor and infant monitor mentioned above.

Thus the scope of the invention should be determined by the appended claims and their legal equivalents, and not by the examples given.

Definition List 1

| Term | Definition |
|---|---|
| Plant | A living organism which generally cannot |
| | directly influence the environment of its |
| | own accord |
| Planter | A container for a plant |
| Robot | A machine or device that operates |
| | automatically or by remote control. |

What is claimed is:

1. A robotic planter, comprising (a) a robot, (b) a planter, (c) the robot situated proximate to the planter.

2. The robot of claim 1, wherein said robot comprises a plurality of sensors selected from the group consisting of light sensors, humidity sensors, and temperature sensors, providing a means for said robot to monitor the environment proximate to the plant.

3. The robot of claim 2, wherein said robot is mobile.

4. The mobile robot of claim 3, wherein said robot comprises (a) a body, (b) a mechanism for propelling the body to travel along a surface, such as a mechanism selected from the group consisting of a plurality of legs and a plurality of rotatable wheels, (c) a plurality of electronic circuits, (d) a sensing mechanism containing at least one device selected from the group consisting of infrared and ultrasonic sensors, (e) an energy source housed within said body.

5. The mobile robot of claim 4, further comprising a base station.

6. The mobile robot of claim 5, further comprising a communications system, wherein the communications system communicates with the base station.

7. The mobile robot of claim 6, wherein the base station communicates with the internet.

8. The mobile robot of claim 4, further comprising a communications system, wherein the communications system communicates with the internet.

9. The mobile robot of claim 5, further comprising (a) a battery as the internal energy source, (b) a circuit for charging the battery, (c) a means of interfacing with the base station to recharge the battery.

10. A method for giving sustenance to a plant, comprising (a) providing a mobile robot situated underneath a container for a houseplant, (b) providing a computer program for controlling the mobile robot, whereby the mobile robot can navigate an environment in search of sustenance.
